(19) United States
(12) Patent Application Publication
(10) Pub. No.: US 2010/0290648 A1
(43) Pub. Date: Nov. 18, 2010

(54) Condenser Microphone

(75) Inventor: RUI ZHANG, Shenzhen (CN)

Correspondence Address: Jamie Zheng, 3524 Waverley Street, Palo Alto, CA, 94306, US

(73) Assignees: AAC ACOUSTIC TECHNOLOGIES (SHENZHEN) CO., LTD, Shenzhen (CN); AMERICAN AUDIO COMPONENTS INC., La Verne, CA (US)

(21) Appl. No.: 12/651,455

(22) Filed: Jan. 1, 2010

(30) Foreign Application Priority Data
May 15, 2009 (CN) 200920131473.X

(51) Int. Cl. H04R 25/00

(52) U.S. Cl. 381/174

(57) ABSTRACT

A condenser microphone is disclosed. The condenser microphone includes a substrate having a cavity, a backplate connected to the substrate, a diaphragm facing to the backplate, and an anchor supporting the diaphragm. A first gap is formed between the diaphragm and the backplate. A groove is arranged on the anchor and the diaphragm partially covers the groove. The diaphragm and the groove forms a second gap communicating with the first gap.

### BACKGROUND OF THE INVENTION

1. Field of the Invention

The present invention generally relates to the art of microphones and, more particularly, to a silicon based condenser microphone.

2. Description of Related Art

Silicon based condenser microphones, known as acoustic transducers, have been researched and developed for more than 20 years. Because of potential advantages in miniaturization, performance, reliability, environmental endurance, low cost, and mass production capability, silicon based microphones are widely recognized to be the next generation product to replace electret condenser microphones (ECM) that has been widely used in communication devices, multimedia players, and hearing aids.

A related silicon based condenser microphone comprises a backplate having a planar plate with a plurality of perforations therein, and a diaphragm parallel and opposed to the backplate for forming a capcitor. The diaphragm can be activated to move along a direction perpendicularly to the planar plate of the backplate.

However, a disadvantage of such microphone is that the air pressure of the air in the gap between the backplate and the diaphragm is unbalanced to that of the air outside. The present invention is provided to solve the problem.

### SUMMARY OF THE INVENTION

In one embodiment of the invention, a condenser microphone comprises a substrate having a through cavity, a backplate connected to the substrate, a diaphragm facing to the backplate, and an anchor supporting the diaphragm and isolating the diaphragm from the backlplate. A first gap is formed between the diaphragm and the backplate. The anchor defines a plurality of grooves at an inner side thereof The diaphragm partially covers the grooves for forming a second gap communicating with the first gap.

Other features of the present invention will become more apparent to those skilled in the art upon examination of the following drawings and detailed description of exemplary embodiments.

### BRIEF DESCRIPTION OF THE DRAWINGS

FIG. 1 is an isometric view of a condenser microphone in accordance with one embodiment of the present invention;

FIG. 2 is an exploded view of the condenser microphone in FIG. 1;

FIG. 3 is an isometric view of the condenser microphone in FIG. 1, half of the microphone being cut off;

FIG. 4 is a top view of the condenser microphone in FIG. 1;

FIG. 5 is a top view of a condenser microphone in accordance with a second embodiment of the present invention.

### DETAILED DESCRIPTION OF THE PREFERRED EMBODIMENT

Reference will now be made to describe the exemplary embodiments of the present invention in detail.

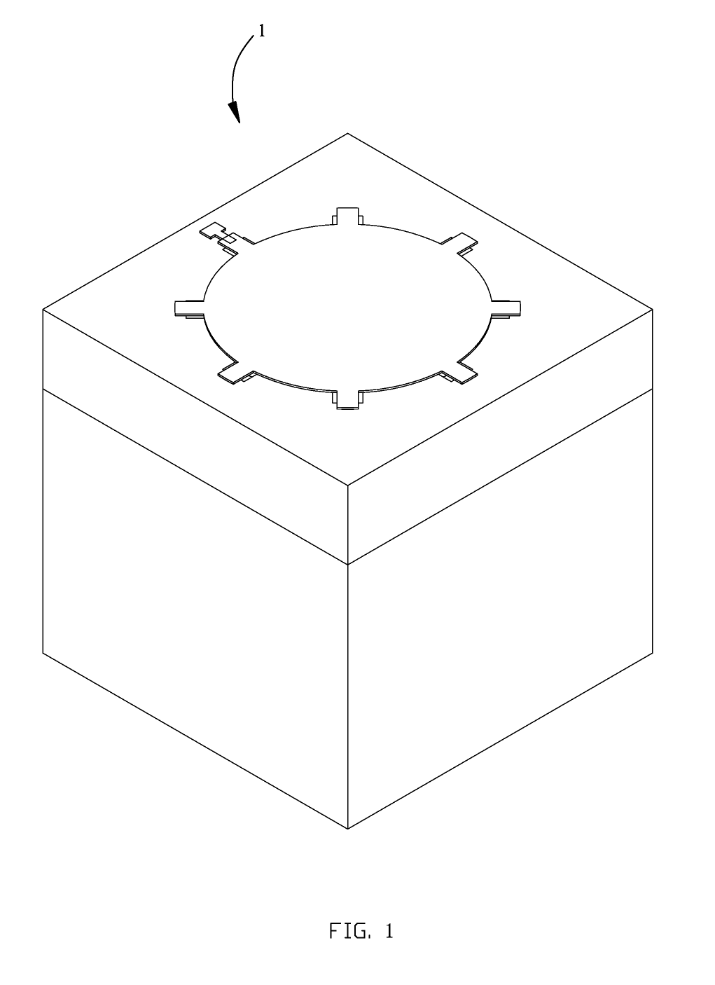

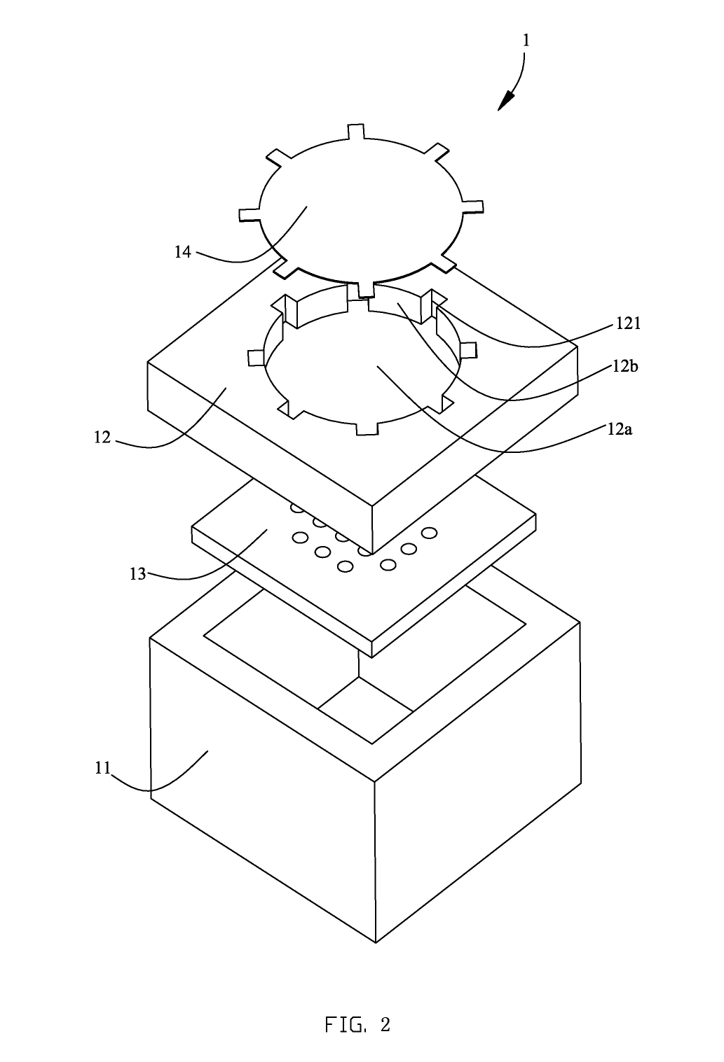

Referring to FIGS. 1-2, a condenser microphone 1 in accordance with a first embodiment of the invention is generally used in a mobile phone for receiving sound waves and then converting the sound waves to electrical signals.

The condenser microphone 1 comprises a substrate 11, a backplate 13 connected to the substrate 11, a diaphragm 14 facing to the backplate 13 and an anchor 12 supporting the diaphragm 11 and isolating the diaphragm 11 from the backlplate 13.

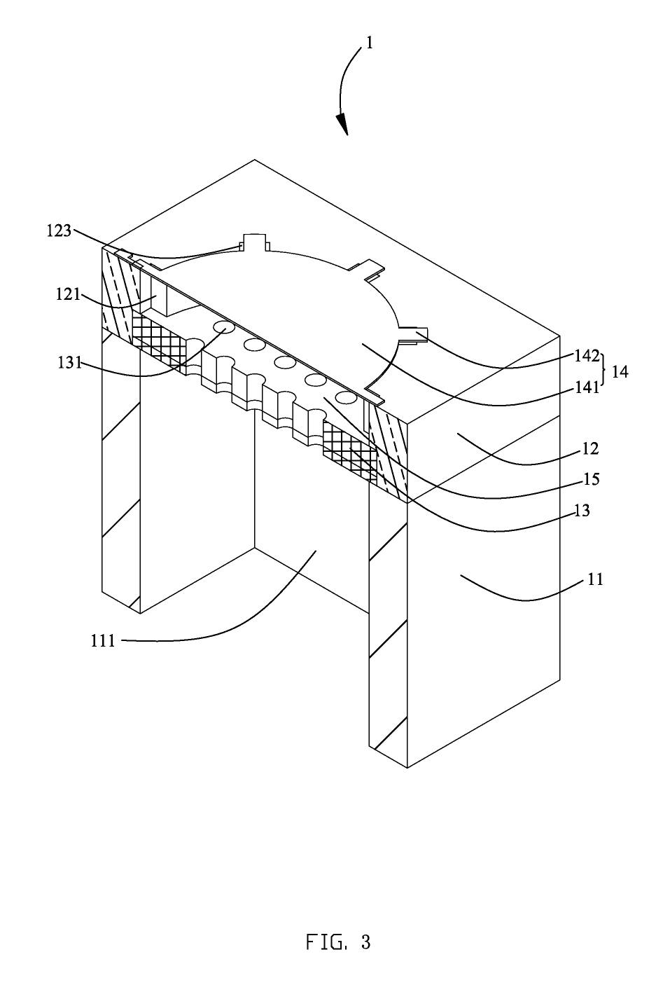

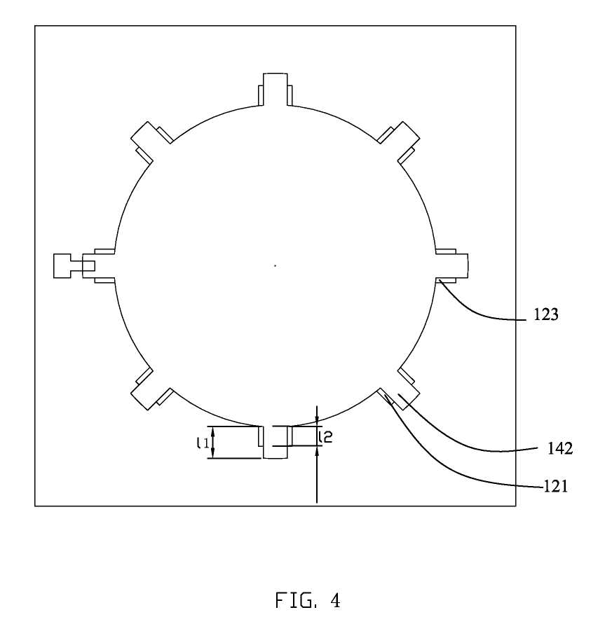

Referring to FIGS. 3-4, the substrate 11 defines a through cavity 111. The diaphragm 14 faces to the backplate 13 and a first gap 15 is accordingly formed between the diaphragm 14 and the backplate 13. The backplate 13 defines a number of sound holes 131. The diaphragm 14 comprises a vibrating member 141 and a plurality of supporting member 142 radially extending from a periphery of the vibrating member 141 along a direction away from a centre of the diaphragm 14. The supporting member 142 is fixed to the anchor 12 for suspending the diaphragm 14.

Referring to FIGS. 1-4, the anchor 12 defines at least one groove 121. A cavity 12a goes through the anchor 12 and the cavity 12a defines an inner wall 12b. The groove 121 is arranged in the inner wall 12b. The supporting member 142 partially covers the groove 121.

Since the supporting member 142 partially covers the groove 121, a second gap 123 is defined there between. The second gap 123 communicates with the first gap 15, which can balance the air pressure of the air in the first gap 15 to that of the air outside.

Referring to FIG. 4, the supporting member 142 defines a first length L1 along a radial direction of the diaphragm 14. The groove 121 defines a second length L2 along the radial direction. The first length L1 is greater than the second length L2, which enables the supporting member 142 to cross the groove 121 for fixing the diaphragm 14 to the anchor 12.

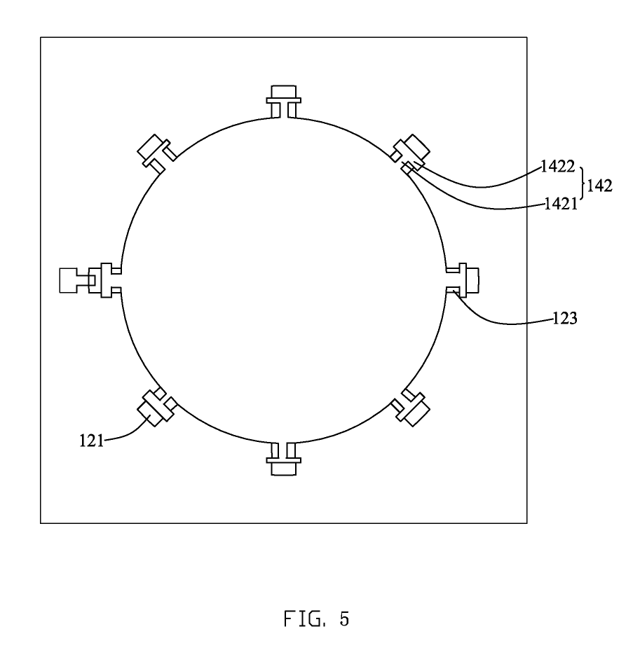

FIG. 5 illustrates a microphone in accordance with a second embodiment of the present invention the microphone has a supporting member 142 partially covers the groove 121. The supporting member 142 defines a first part 1421 extending along a radial direction of the diaphragm 14 and a second part 1422 extending perpendicular to the radial direction. A middle portion of the second part 1422 is connected to an end of the first part 1421. The second part 1422 strides over the groove 121 and partially covers the groove 121.

When the diaphragm is activated to move relative to the backplate, the vibrating member vibrates perpendicularly to the backplate, while the supporting member does not vibrate, which reduces stress concentrations and improves the performance of resisting impact of the condenser microphone. Such condenser microphone as mentioned above has lower request for the dimension of the second gap, so it predigests the craft prosses.

While the present invention has been described with reference to a specific embodiment, the description of the invention is illustrative and is not to be construed as limiting the invention. Various of modifications to the present invention can be made to the preferred embodiment by those skilled in the art without departing from the true spirit and scope of the invention as defined by the appended claims.

What is claimed is:

1. A condenser microphone comprising:
a substrate having a through cavity;
a backplate connected to the substrate and defining a plurality of sound holes;
a diaphragm opposed to the backplate for forming a capacitor;
a first gap defined between the diaphragm and the backplate;
an anchor supporting the diaphragm and isolating the diaphragm from the backlplate, the anchor defining at least one groove partially covered by the diaphragm for forming a second gap communicating with the first gap.

2. The condenser microphone as described in claim 1, wherein the anchor defines a cavity in a middle portion thereof, the cavity having an inner wall and the groove is arranged in the inner wall.

3. The condenser microphone as described in claim 1, wherein the diaphragm comprises a vibrating member and a supporting member extending from a periphery of the vibrating member, the supporting member partially covering the groove for forming the second gap.

4. The condenser microphone as described in claim 3, wherein the supporting member defines a first length along a radial direction of the diaphragm and the groove defines a second length along a radial direction of the cavity, the first length being longer than the second length.

5. The condenser microphone as described in claim 3, wherein the supporting member defines a first part extending along a radial direction of the diaphragm and a second part perpendicular to the first part with a middle portion connected with the first part.

6. The condenser microphone as described in claim 5, wherein the second part strides over the groove.

7. A condenser microphone comprising:
a substrate having a through cavity;
a backplate located above the substrate;
a diaphragm opposed to the backplate for forming a capacitor;
an anchor supporting the diaphragm for forming a first gap between the diaphragm and the backplate; wherein
the diaphragm partially covers the anchor for forming a second a second gap communicating with the first gap.

8. The condenser microphone as described in claim 7, wherein the anchor defines a cavity in a middle portion thereof, the cavity having an inner wall and the groove is arranged in the inner wall.

9. The condenser microphone as described in claim 7, wherein the diaphragm comprises a vibrating member and a supporting member extending from a periphery of the vibrating member, the supporting member partially covering the groove for forming the second gap.

10. The condenser microphone as described in claim 9, wherein the supporting member defines a first length along a radial direction of the diaphragm and the groove defines a second length along a radial direction of the cavity, the first length being longer than the second length.

11. The condenser microphone as described in claim 9, wherein the supporting member defines a first part extending along a radial direction of the diaphragm and a second part perpendicular to the first part with a middle portion connected with the first part.

12. The condenser microphone as described in claim 11, wherein the second part strides over the groove.
